(19) United States
(12) Patent Application Publication
(10) Pub. No.: US 2017/0080897 A1
(43) Pub. Date: Mar. 23, 2017

(54) SECURING A MOTOR VEHICLE

(71) Applicant: Robert Bosch GmbH, Stuttgart (DE)

(72) Inventor: Stefan Nordbruch, Kornwestheim (DE)

(21) Appl. No.: 15/265,339

(22) Filed: Sep. 14, 2016

(30) Foreign Application Priority Data
Sep. 18, 2015 (DE) 102015217920.6

(51) Int. Cl. B60R 25/102; E01F 13/04; G06K 9/00; E04H 6/08; G08G 1/00; G08G 1/017

(52) U.S. Cl. CPC B60R 25/102; G08G 1/207; G08G 1/0175; G06K 9/00771; E04H 6/08; E01F 13/042

(57) ABSTRACT

A method for securing a motor vehicle against unauthorized removal from an AVP parking facility includes steps of receiving, from the motor vehicle, information regarding a driving state of the motor vehicle, of determining that the motor vehicle is in transit in the area of the parking facility, of determining that the motor vehicle is traveling outside of a parking or retrieval process controlled independently of a driver, and of triggering an action.

### CROSS REFERENCE

The present application claims the benefit under 35 U.S.C. §119 of German Patent Application No. DE 102015217920.6 filed on Sep. 18, 2015, which is expressly incorporated herein by reference in its entirety.

### FIELD

The present invention relates to securing a motor vehicle. The present invention particularly relates to securing a motor vehicle in a parking facility.

### BACKGROUND INFORMATION

A parking facility having multiple parking spaces is designed to support so-called AVP parking (automated valet parking). In this instance, the driver is able to bring the motor vehicle to a transfer point and to leave it there. The motor vehicle is then guided to one of the parking spaces and parked there in automated fashion and without driver intervention. If the driver wants to use the motor vehicle again, then the motor vehicle can be guided, likewise in automated fashion, from the parking space to the transfer point, where the driver receives the motor vehicle.

If the motor vehicle is stolen from the parking space, then it is possible that the loss of the motor vehicle is noticed only relatively late, that is, usually when the owner attempts to access the motor vehicle. It is an objective of the present invention to provide improved technology for securing a motor vehicle in an AVP parking facility.

In accordance with an example embodiment of the present invention, a method is provided for securing a motor vehicle against unauthorized removal from an AVP parking facility including steps of receiving, from the motor vehicle, of information regarding a driving state of the motor vehicle, of determining that the motor vehicle is in transit in the area of the parking facility, of determining that the motor vehicle is traveling outside of a parking or retrieval process controlled independently of a driver, and of triggering an action.

The parking facility equipped to support an AVP process is designed to track the driver-independent guidance of the motor vehicle in the area of the parking facility. This may be necessary in order to improve the automated guidance of the motor vehicle in the area of the parking facility in the context of the driver-independent parking or retrieval process. This makes it possible for example to reduce the risk of a collision with another motor vehicle or an object in the parking facility, which may be detected from the motor vehicle only very late or not at all.

For example, on the basis of the information, it is possible to determine a position and/or a driving state of the motor vehicle. The driving state may include movement information, for example a longitudinal or transverse acceleration or a longitudinal or transverse speed of the motor vehicle. Additional information may include a planned guidance of the motor vehicle or a state of a system on board of the motor vehicle.

By using the already installed infrastructure of the AVP parking facility, it is possible to secure the motor vehicle simply and securely against unauthorized removal. It is possible to notice the removal of the motor vehicle very quickly so that the initiated action may be effective.

The action may include the detection of a confirmation of a person responsible for the motor vehicle or the parking facility. Expressed differently, a responsible person may be queried before performing the action. If the person confirms that the removal of the motor vehicle is to be allowed, the action may be suppressed. If on the other hand the person confirms that the removal is to be prevented or if the consent to the removal of the motor vehicle is not given over longer than a predetermined time period—for example 10 to 30 seconds—then the action may be triggered or performed. It is thus possible to prevent a false alarm in an improved manner. The responsible person may nevertheless be informed promptly of the attempt to remove the motor vehicle.

Fundamentally, at least two different types of action may be triggered, which may also be combined with each other. The first type of action concerns the prevention of the complete removal of the motor vehicle, while the second type of action concerns the documentation of the removal process.

In one specific embodiment, the action includes the mounting of a physical barrier against a departure of the motor vehicle from the parking facility. Such a barrier may be for example a sliding gate, a rolling shutter gate, a barrier emerging from the floor or a barrier boom. The motor vehicle must then remain in the area of the parking facility until there is a conclusive clarification whether the removal of the motor vehicle from the area of the parking facility is to be allowed or not.

In another specific embodiment, the action includes the output of a message. The message may be output in particular to an owner or driver of the motor vehicle, to an official agency such as the police, to a security service or to supervisory personnel of the parking facility. A responsible person may thereby be summoned quickly to act and, if applicable, intervene in time to check the unauthorized removal process.

Preferably, additional information is detected in the area of the parking facility and is recorded over a predetermined past time period. In this connection, it is possible for the above-mentioned message to include the additional information. This additional information may include in particular camera or video images from the area of the parking facility. Furthermore, additional information, which was gathered for example in connection with a parking process of the motor vehicle, may be collected or stored. This information may include for example a license plate of the motor vehicle, an arrival time, a removal time, respectively as date and time, or other information. This information may also be processed or preprocessed, for example in that a person driving the motor vehicle is represented in an enlarged or extracted fashion from the camera or video image.

A computer program product includes program code means for carrying out the described method when the computer program product runs on a processing device or is stored on a computer-readable data carrier.

A parking system includes a parking facility having at least one parking space for parking a motor vehicle, a communication device for receiving, from the motor vehicle, information regarding a driving state of the motor vehicle, a processing device for supporting a driver-independent process of parking or retrieving the motor vehicle. The processing device is designed to determine, on the basis of the received information, that the motor vehicle is traveling in the parking facility outside of a parking or retrieval process controlled independently of a driver, and thereupon to trigger an action.

The processing device is preferably designed to carry out the method described above. For this purpose, the processing device may include a programmable microcomputer, on which the above-mentioned computer program product is executed.

The present invention is described in more detail below with reference to the figures.

### BRIEF DESCRIPTION OF THE DRAWINGS

FIG. 1 shows a system including an AVP parking facility and a motor vehicle.

FIG. 2 shows a flow chart of a method for securing the motor vehicle in the parking facility from FIG. 1.

### DETAILED DESCRIPTION OF EXAMPLE EMBODIMENTS

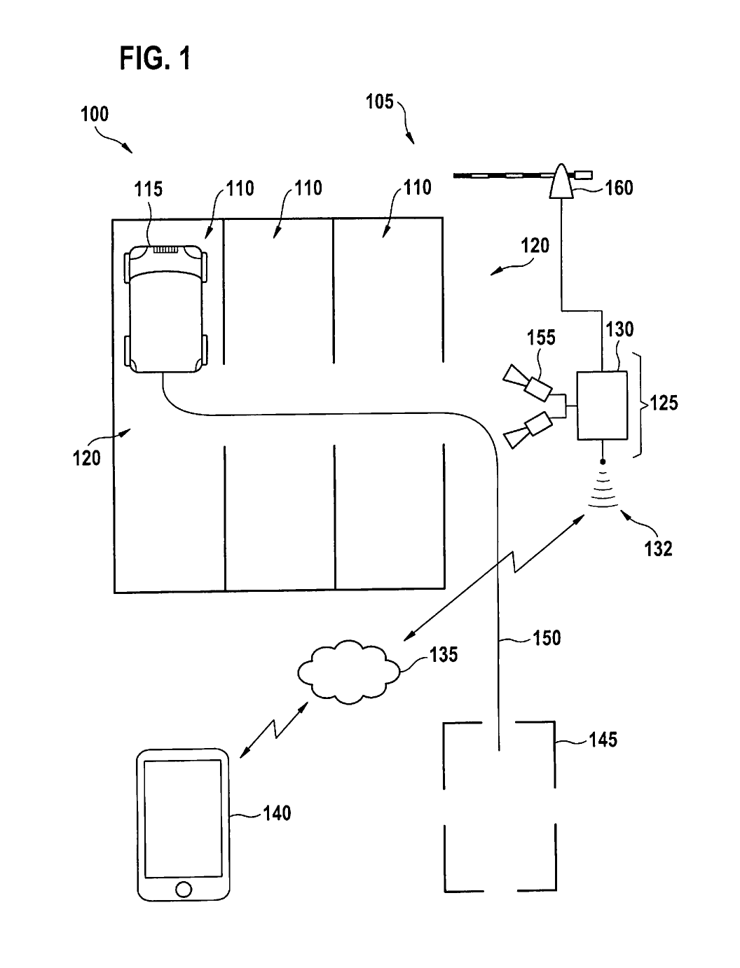

FIG. 1 shows a system 100 including a parking facility 105. Parking facility 105 may in the open or in a parking garage and includes a number of parking spaces 110, respectively for parking one motor vehicle 115, and usually one or multiple traffic areas 120, via which the parking spaces 110 may be reached.

Usually, a management device 125 including a processing device 130 is provided in order to organize or control the parking or retrieval of motor vehicles 115 in parking facility 105. Management device 125 may be used for example to perform a reservation or a billing of a parking process. Preferably, processing device 130 is connected to a network 135 by way of a communication device 132 so as to be able to perform, for example, a reservation or a billing process via a remote device 140. Network 135 may be embodied to be partially wireless. In particular, it is possible to utilize a part of the Internet or of a mobile network for network 135. Device 140 may be for example a computer or a mobile device, in particular a so-called smart phone or a tablet computer.

Parking facility 105 is designed to support a so-called AVP parking process (automated valet parking). For this purpose, a transfer point 145 is provided, at which a motor vehicle 115 may be dropped off or received. For this purpose, the movement of motor vehicle 115 between transfer point 145 and a parking space 110 along a route 150 may be controlled independently of the driver. For this purpose, management device 125 usually has a number of sensors 155 for scanning parking facility 105, particularly traffic areas 120 or parking spaces 110.

In different specific embodiments, motor vehicle 115 is controlled primarily by processing device 130, primarily by a processing device on board motor vehicle 115 or in cooperation between the two processing devices. For this purpose, it is possible to exchange information between motor vehicle 115 and management device 125, usually via a local wireless network or via network 135. Sensors 155 may include in particular a camera, a video camera, a radar sensor, a lidar sensor, a light barrier, a capacitive or inductive proximity sensor, an induction loop, an ultrasonic sensor or practically any other sensor that is able to contribute to supporting a control of motor vehicle 115 in the area of parking facility 105 and in particular to scanning an area around motor vehicle 115.

In a first variant, motor vehicle 115 is generally controlled by management device 125. For this purpose, parking facility 110 is scanned by sensors 155, the position and movement of motor vehicle 115 is determined, and control information is transmitted to motor vehicle 115. Sensors of motor vehicle 115 are also used to scan the surroundings of motor vehicle 115; sensor information and, if indicated, additional information of the motor vehicle being transmitted to management device 125.

In a second variant, motor vehicle 115 is controlled by an on-board control device, sensor information of management device 125 improving the processing. Here too, driving information is transmitted to management device 125.

In a third variant, motor vehicle 115 itself assumes the control practically entirely. Management device 125 usually also provides position information, for example of destination parking space 110. The driving state of motor vehicle 115 is usually transmitted in this case as well to management device 125 for monitoring and avoiding collisions.

Management device 125 is designed to monitor parking facility 105 and in particular to detect motor vehicles 115 moving in the area of parking facility 105. The present invention provides for this functionality to be used for securing a motor vehicle 115 against unauthorized removal from parking facility 105 or a parking space 110. If a person should attempt, for example, to steal a motor vehicle 115 parked in a parking space 110, the person must move it through an area of parking facility 105 that is monitored by sensors 155 in order to leave the area of parking facility 105. Management device 125 is able to detect motor vehicle 115 in the process and is able to trigger an action with the aim, for example, of documenting the removal process or preventing the complete removal of motor vehicle 115 from the area of parking facility 105. In the latter case, it is possible in particular to activate a physical barrier 160 in the area of parking facility 105. Barrier 160 may include a barrier boom, a gate or another movable obstruction.

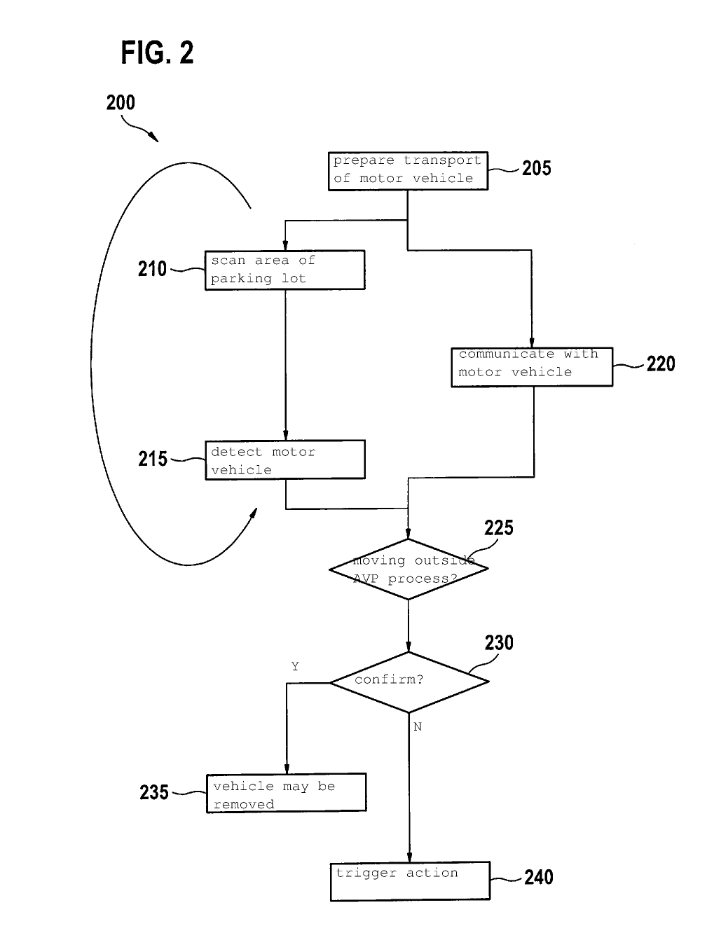

FIG. 2 shows a flow chart of a method 200 for securing motor vehicle 115 in parking facility 105 from FIG. 1.

In a typical AVP sequence, a transport of a motor vehicle 115 between transfer point 145 and a parking space 110 is prepared in a step 205. Motor vehicle 115 is then guided along route 150, an area of parking lot 105 being scanned in a step 210 by the infrastructure of parking facility 105, in particular by management device 125, and motor vehicle 115 being detected in a subsequent step 215. Information that was scanned in step 210 may be additionally stored. In particular, it is possible to store information in a predetermined past time window for later use.

Usually, in parallel with steps 210 and 215, a communication 220 with motor vehicle 115 takes place in order to improve the guidance on route 150. In one specific embodiment, motor vehicle 115 transmits, at its own discretion or in response to a request from management device 125, its position and/or its driving state to management device 125. In another specific embodiment, it is not necessary to transmit a position of motor vehicle 115 via network 135 to management device 125, but rather the position may be determined for example by triangulation from multiple receivers of communication device 132. The determination of the position of motor vehicle 115 in this instance likewise occurs on the basis of communication data.

Steps 210 through 220 usually run in a loop in a recurring manner, it being possible for steps 210 and 215 on the one hand and step 220 on the other hand to be executed in a synchronized manner or concurrently.

Steps 205 through 220 are normally comprised by an AVP process, but may be used at least partially in order to secure a motor vehicle 115 against unauthorized removal from the area of parking facility 105.

In particular, it is possible to use findings from steps 210 and 215 in order to determine a motor vehicle 115 that is traveling outside of an AVP process in the area of parking facility 105. Since the guidance of motor vehicle 115 on route 150 in the context of an AVP process is usually supported by management device 125 on the basis of communication information with motor vehicle 115, it is possible in a step 225 to decide easily whether a motor vehicle 115 moving the area of parking facility 105 is traveling outside of an AVP process. Step 225 is usually connected with a driver-independent guidance of motor vehicle 115 in parking facility 110. This function is not represented in more detail in FIG. 2. In one specific embodiment, it is also possible to determine that a motor vehicle 115 is traveling outside of an AVP process if it is detected for example by sensors 155, but it is not possible to establish a communication between motor vehicle 115 and management device 125. In particular, this may be the case if motor vehicle 115 does not react to a communication attempt by management device 125 or if it breaks off the communication.

If it has been determined that motor vehicle 115 is traveling outside of an AVP process in parking facility 110, then it is optionally possible to query a responsible person in a step 230. If the result of this query is positive, that is, if the person confirms that motor vehicle 115 may be removed from the area of parking facility 105, then it is possible to terminate method 200 in a step 235. Thus a driver who retrieves his motor vehicle early from parking facility 110 is able to identify himself as authorized so that no action is triggered. Otherwise, or if a consent of the responsible person in step 230 fails to be given for longer than a predetermined time span, it is possible to trigger one or multiple actions in a step 240. These actions may be aimed at physically preventing the final removal of motor vehicle 115 from the area of parking facility 105, at documenting the removal process or outputting an indication to a responsible person. In the documentation or the indication, it is possible in particular to fall back on the information stored in step 210.

What is claimed is:

1. A method for securing a motor vehicle against unauthorized removal from an AVP parking facility, comprising:
receiving, from the motor vehicle, information regarding a driving state of the motor vehicle;
determining that the motor vehicle is traveling in the area of the parking facility;
determining that the motor vehicle is traveling outside of a parking or retrieval process controlled independently of the driver; and
triggering an action.

2. The method as recited in claim 1, wherein on the basis of the information, at least one of a position and a driving state, of the motor vehicle is determined.

3. The method as recited in claim 1, wherein the parking facility is designed to support a driver-independent guidance of the motor vehicle between a transfer point and a parking space in the context of a driver-independent parking or retrieval process.

4. The method as recited in claim 1, wherein the action includes detecting a confirmation of a person responsible for the motor vehicle or the parking facility.

5. The method as recited in claim 1, wherein the action includes mounting of a physical barrier against a departure of the motor vehicle from the parking facility.

6. The method as recited in claim 1, wherein the action includes outputting a message.

7. The method as recited in claim 5, wherein in the area of the parking facility, additional items of information are detected and are recorded over a predetermined past time period and wherein the message includes the additional items of information.

8. The method as recited in claim 7, wherein the items of information include one of a camera image, an image sequence, a date, a time and reservation information for usage of the parking space.

9. A non-transitory computer-readable storage medium storing a computer program product having program code for securing a motor vehicle against unauthorized removal from an AVP parking facility, the program code, when executed by a processing device, causing the processing device to perform:
receiving, from the motor vehicle, information regarding a driving state of the motor vehicle;
determining that the motor vehicle is traveling in the area of the parking facility;
determining that the motor vehicle is traveling outside of a parking or retrieval process controlled independently of the driver; and
triggering an action.

10. A parking system, comprising:
a parking facility having at least one parking space for parking a motor vehicle;
a communication device for receiving, from the motor vehicle, information regarding a driving state of the motor vehicle; and
a processing device for supporting a driver-independent parking or retrieval process of the motor vehicle, the processing device being designed to determine, on the basis of the received information, that the motor vehicle is traveling in the parking facility outside of a parking or retrieval process controlled independently of a driver, and thereupon to trigger an action.
